(19) United States
(12) Patent Application Publication
(10) Pub. No.: US 2022/0081101 A1
(43) Pub. Date: Mar. 17, 2022

(54) AIRFOIL HAVING PROPELLER IN SLOT

(71) Applicant: Pritesh Mody, San Diego, CA (US)

(72) Inventor: Pritesh Mody, San Diego, CA (US)

(21) Appl. No.: 17/019,112

(22) Filed: Sep. 11, 2020

(51) Int. Cl. B64C 11/48; B64C 3/20

(52) U.S. Cl. CPC B64C 11/48; B64C 2003/143; B64C 3/20

(57) ABSTRACT

An airfoil segment for inclusion in an aircraft wing is provided. The multi-element slotted airfoil segment has at least one propeller operatively located in a slot communicating therethrough for improved low speed performance and control. Upstream propeller flow field effects generated allow the front portion of the airfoil segment to be structurally efficient thicker airfoils with higher lift-to-drag laminar airfoils or higher maximum lift coefficient designs. The downstream propeller flow field acting on the aft portion of the airfoil segment increases lift and allows flaps on the aft portion to provide control forces/moments at static or low flight speeds for short or vertical take-off.

### BACKGROUND OF THE INVENTION

### 1. Field of the Invention

The present invention relates generally to airfoils as for example employed in construction of air or ground or underwater vehicles. More particularly it relates to a slotted airfoil segment configuration for an aircraft wing which is employable for propeller driven conventional and vertical take-off air vehicle wings, wherein a propeller is located within the slot.

### 2. Prior Art

Conventionally, many subsonic conventional and vertical take-off air vehicles are propeller driven for efficiency. A propeller is a device with a rotating hub and radially projecting blades composed of airfoils that produce lift and drag. The propeller converts rotational power from an engine/motor to linear thrust force that propels the air vehicle.

Such a thrust producing propeller gradually increases the velocity of the incoming flow up to the propeller plane and downstream therefrom, as it reaches almost twice the value at the propeller plane over a distance equal to a few propeller diameters. The propeller also gradually reduces air pressure up to the propeller plane whereupon the air pressure is increased abruptly in a downstream flow. Downstream of the propeller, the air pressure is decreased gradually again until it reaches the freestream value.

For forward flight the configuration is conventionally either a “pusher” where the propeller is positioned behind some air vehicle component, or a “tractor” where the propeller is positioned ahead of some air vehicle component. The tractor configuration creates a propeller slipstream on the downstream wing which is known to increase wing lift and drag. This pulsating propeller slipstream, along with swirl velocity components produced by a single propeller, are, however, detrimental to maintaining laminar flow on a tractor propeller wing configuration.

The aft located propulsion system weight associated with such a pusher configuration, moves the aircraft center of gravity aft which is known to be detrimental to aircraft stability. The centerline pusher propeller configuration has also been paired with tails located downstream on twin booms to take advantage of the propeller slipstream for improved tail effectiveness. For wing mounted propellers, both tractor and pusher configurations can improve the stall angle and maximum lift coefficient of wings located in the propeller flow field.

Other configurations include the over-the-wing positioning of the propeller and the channel wing configuration, where the propeller is placed adjacent the wing somewhere in between the wing leading and trailing edge. For the over-the-wing propeller positioning, the engine driving the propeller is typically also placed above the wing creating a thrust axis offset above the wing. For the channel wing positioning configuration, the propeller and engine are placed in the wing plane, and the wing is locally curved around the propeller circumference.

These configurations maintain propeller tips near the wing surface and can increase lift and reduce drag on the adjacent wing. However, this type of positioning adds structural complexities which are coupled to the choice of propeller diameter.

Micro air vehicles (large insect/small bird sized) have explored propellers in wing slots but with a focus on control and mostly for low aspect ratio wings. At these scales, natural laminar flow can be readily attained but that becomes increasingly harder as the scale (and flow Reynolds number) is increased. In addition, at larger scales and especially with employment of multiple smaller propellers, the motor(s) driving the propellers may be largely encased in the wing segment to eliminate its drag.

Several strategies are employed for vertical take-off and landing air vehicles with most solutions employing one or more propellers orientated to produce thrust force in a vertical direction. Control of the vehicle at static or low flight speeds typically requires differential thrust across multiple rotors or control of the rotor blade pitch angles. Both of these strategies make the aircraft difficult to maneuver while maintaining altitude. Control effectors composed of a movable surface on the wing or tail are typically not effective due to the lack of sufficient air flow unless it is created locally by the spinning propeller.

To transition from vertical to horizontal flight some vehicles tilt the thrust producing component or the entire vehicle, while some vehicles use separate propulsors for each flight segment. All these systems require complex, often high power, actuation mechanisms or multiple rotors that are not efficient to operate all flight segments.

Other multi-element airfoils consist of multiple airfoil segments that maintain or can be actuated to maintain air gaps between different forward and aft elements. These designs have typically been used for high-lift systems on conventional take-off and landing air vehicle. These designs have also been tailored to maximize natural laminar flow or to delay for the formation of shocks at higher speeds by permitting pressure distributions on airfoils not attainable on single element, un-slotted, airfoils.

The forgoing examples of related art in the field of airfoil segment and aircraft wing configurations, and limitations related therewith are intended to be illustrative and not exclusive, and they do not imply any limitations on the slot-positioned propeller airfoil segment invention described and claimed herein. Various limitations of the related art will become apparent to those skilled in the art upon a reading and understanding of the specification below and the accompanying drawings.

### SUMMARY OF THE INVENTION

The airfoil segment configuration system herein, having a slot-located propeller, provides significant enhancement to the art aircraft wing structure. By aircraft wing structure as used herein is meant any rectangular or non rectangular structure which is employed upon an aircraft to generate lift, whether straight, tapered, swept rearward, or circular, or any other wing shape or configuration in which a slot-positioned propeller is operatively positioned.

The airfoil segment system herein is positionable in a wing for an aircraft having a forward airfoil element or front portion located in front of the formed slot having a propeller operatively portioned therein. By operatively positioned is meant that the propeller is engaged to an engine or motor providing rotation thereto to generate thrust. The location of the propeller in a slot behind the front portion and in front of an aft portion operates to produce aerodynamic lift and provides for the production of both a propulsive force for the air vehicle and for a local flow field change for both the forward portion and aft portion thereof.

Additionally, the airfoil system herein, when employed in a preferred embodiment in an aircraft wing, provides for a forward element boundary ingestion by the slot-positioned propeller, which enhances performance thereby resulting in reduced engine fuel flow and power consumption. By propeller herein is meant any powered rotating assembly of blades which is employable in an aircraft to generate thrust and a propulsive force. While the propellers herein are depicted with blades having tips rotating in a free flowing area above and below the slot, the propeller may also be surrounded by a duct or shroud which is well known in the art.

The airfoil segment, herein positioned in a wing, generates propeller flow field effects which allow the front portion of the airfoil segment to be structurally efficient thicker airfoils or higher lift-to-drag laminar airfoils or higher maximum lift coefficient designs. In all modes, the downstream propeller flow field effects on the aft portion of the segment increases lift and allows flaps on the aft portion to provide enhanced control forces/moments at static or low flight speeds for short or vertical take-off.

In all modes of the system, an airfoil segment, as employed as part of an aircraft wing, has an elongated slot communicating between an upper surface and lower surface thereof. The slot has a length along the longitudinal axis. This length exceeds the diameter of the plane or circular pattern formed by the tips of the rotating blades of the propeller. Further this length is sufficient between the two ends of the slot, to accommodate any thermal and/or expansion of blades while in motion.

The total width of the slot is sufficient to accommodate any prop pitch change which will occur during use and provide sufficient clearance for any flexing of the propeller blades while rotating. The distance of this total width of the formed slot is formed by a first portion, which is the slot width ahead of the plane of rotation of the propeller, and a second portion, which is a slot width rearward of the plane of rotation of propeller. By plane of rotation is meant a planar area between the tips of the rotating blades of the propeller, when unflexed, and the central hub spinning the blades. Preferably, the width of the first portion of the slot ahead of the propeller is less than the width of the second portion of the slot, positioned behind the propeller and the plane of rotation formed thereby.

The positioning of the slot within the airfoil segment forming a wing locates a front edge of the slot positioned between the propeller and the forward portion of the segment and leading edge of the wing, to form a front portion. This front portion is substantially 40-80% of the total width of the airfoil segment forming the wing. By total width of the airfoil segment is meant the distance running between the leading edge of the front portion of the airfoil segment and a rear edge of a flap positioned behind the slot. By flap where used herein is meant any control surface which actuable on a wing, including a flap or aileron, or other actuable surface.

The aft portion, which includes a flap, preferably has an aft width or distance which is substantially 10-40% of the wing chord or the total width (TW) of the airfoil segment between the leading edge of the front portion and the rear edge of the flap. This aft portion may be formed entirely by the flap, or may have a fixed area positioned between the slot and the flap.

In a particularly preferred mode of the system herein, two counter rotating propellers may be operatively located within the slot. The slot length, as noted above, will be sufficiently large in distance to accommodate the blades from tip to tip while rotating, and the slot width will be sufficient in distance to accommodate any pitch changes, flex, or thermal or mechanical expansion of the blades during use. These counter rotating propellers will serve to yield a more uniform airflow therefrom versus a single slot-positioned propeller.

Additionally in another preferred configuration of the system herein, two rearward positioned flaps form all or part of the aft section and are provided which can be independently rotated. Because a single slot-positioned propeller rotates in a single fixed direction, it generates air flow field differences on the side where the propeller is moving up, versus the side of the propeller where it is moving downward. In addition there is non uniform air flow from hub to tip of the propeller. All of these effects change as the propeller RPM changes. Thus, the system will work more efficiently with two flaps present, thereby providing multiple movable control surfaces to compensate for such effects rearward of the propeller.

With respect to the above description, before explaining at least one preferred embodiment of the herein disclosed airfoil segment configuration for inclusion in an aircraft wing system in detail, it is to be understood that the invention is not limited in its application to the details of construction and to the arrangement of the components in the following description or illustrated in the drawings. The invention herein described, is capable of other embodiments and of being practiced and carried out in various ways which will be obvious to those skilled in the art. Also, it is to be understood that the phraseology and terminology employed herein are for the purpose of description and should not be regarded as limiting.

As such, those skilled in the art will appreciate that the conception upon which this disclosure is based, may readily be utilized as a basis for designing of other aircraft wing structures, methods and systems for carrying out the several purposes of the present disclosed device. It is important, therefore, that the claims be regarded as including such equivalent construction and methodology insofar as they do not depart from the spirit and scope of the present invention.

As used in the claims to describe the various inventive aspects and embodiments, “comprising” means including, but not limited to, whatever follows the word “comprising”. Thus, use of the term “comprising” indicates that the listed elements are required or mandatory, but that other elements are optional and may or may not be present. By “consisting of” is meant including, and limited to, whatever follows the phrase “consisting of”. Thus, the phrase “consisting of” indicates that the listed elements are required or mandatory, and that no other elements may be present. By “consisting essentially of” is meant including any elements listed after the phrase, and limited to other elements that do not interfere with or contribute to the activity or action specified in the disclosure for the listed elements. Thus, the phrase “consisting essentially of” indicates that the listed elements are required or mandatory, but that other elements are optional and may or may not be present depending upon whether or not they affect the activity or action of the listed elements. Finally, the term “substantially” if not otherwise defined, means plus or minus ten percent.

It is an object of this invention to provide a slotted airfoil segment and propeller configuration for an air vehicle wing having a leading edge produce aerodynamic lift or down force.

It is a further object of the invention to provide an airfoil design having a rotating propeller positioned in an opening or slot positioned between the leading edge of the forward element and trailing edge of the wing segment, to enable the production of both a propulsive force for the air vehicle and a local flow field change for both the forward and aft elements thereof.

It is yet an additional object of this invention to provide a forward element boundary ingestion by the slot-positioned propeller, which enhances performance resulting in reduced engine fuel flow and power consumption.

It is an additional object of this invention to provide an airfoil design and system which combines to provide a favorable upstream flow field from the propeller to enable low drag laminar flow on the forward element; a favorable downstream flow field from the propeller to enable highly effective control surfaces on the aft element, even in static or low speed conditions; and a forward element boundary layer ingestion resulting in reduced engine fuel flow and power consumption.

Other objects, features, and advantages of the present airfoil configuration, as well as the advantages thereof over existing prior art, will become apparent from the description to follow, and are accomplished by the improvements described in this specification and hereinafter described in the following detailed description which fully discloses the invention, but should not be considered as placing limitations thereon.

### BRIEF DESCRIPTION OF DRAWING FIGURES

The accompanying drawings, which are incorporated herein and form a part of the specification, illustrate some, but not the only or exclusive, examples of embodiments and/or features of the aircraft wing configuration. It is intended that the embodiments and figures disclosed herein are to be considered illustrative rather than limiting.

In the drawings:

FIG. 1 shows a front perspective view of a mode of the airfoil herein, showing a leading edge thereof and showing the propeller operatively positioned in a slot located between a front portion of the airfoil and a rear portion of the airfoil.

FIG. 2 depicts a top plan view of the airfoil system as in FIG. 1 and shows a front portion of the airfoil and a rear portion of the airfoil, and a slot located therebetween.

FIG. 3 shows a rear view of the airfoil system of FIGS. 1-2 and depicts the propellor communicating through a slot running between the top surface and bottom surface and shows the diameter D of the plane of rotation P which is determined by the circumference C thereof.

FIG. 4 depicts a top view of another preferred mode of the aircraft airfoil system herein, showing a particularly preferred mode of the system having two counter rotating propellers operatively positioned within a slot communicating through the airfoil section.

FIG. 5 shows a rear perspective view of the airfoil system in another mode wherein the airfoil segment employed with a wing, includes two slots each having a propeller operatively positioned therein in front of a respective wing flap.

FIG. 6 is a front perspective view of the airfoil segment of FIG. 5.

FIG. 7 shows a top plan view of the airfoil system of FIG. 6.

FIG. 8 shows a rear view of the airfoil segment of FIGS. 6-7.

FIG. 9 shows an example of prior art conventional aircraft airfoil configurations where typically a front portion is sized between sixty to eighty percent of the total width of the segment between a leading edge and trailing edge.

FIG. 10 shows a graphic depiction of the forward propeller flow field effects and the downstream propeller flow field effects communicated to the aft portion of the segment provided by the disclosed airfoil segment and preferred configurations of the forward and rearward portions.

FIG. 11 depicts an example of a preferred slotted airfoil segment configuration for inclusion in an aircraft wing system herein.

FIG. 12 is a view of variations of preferred wing configurations enabled by the airfoil segment herein such as that of FIG. 4.

Other aspects of the present airfoil segment invention shall be more readily understood when considered in conjunction with the accompanying drawings, and the following detailed description, neither of which should be considered limiting.

### DETAILED DESCRIPTION OF THE PREFERRED

### Embodiments of the Invention

In this description, the directional prepositions of up, upwardly, down, downwardly, front, back, top, upper, bottom, lower, left, right and other such terms refer to the device as it is oriented and appears in the drawings and are used for convenience only, and they are not intended to be limiting or to imply that the device has to be used or positioned in any particular orientation.

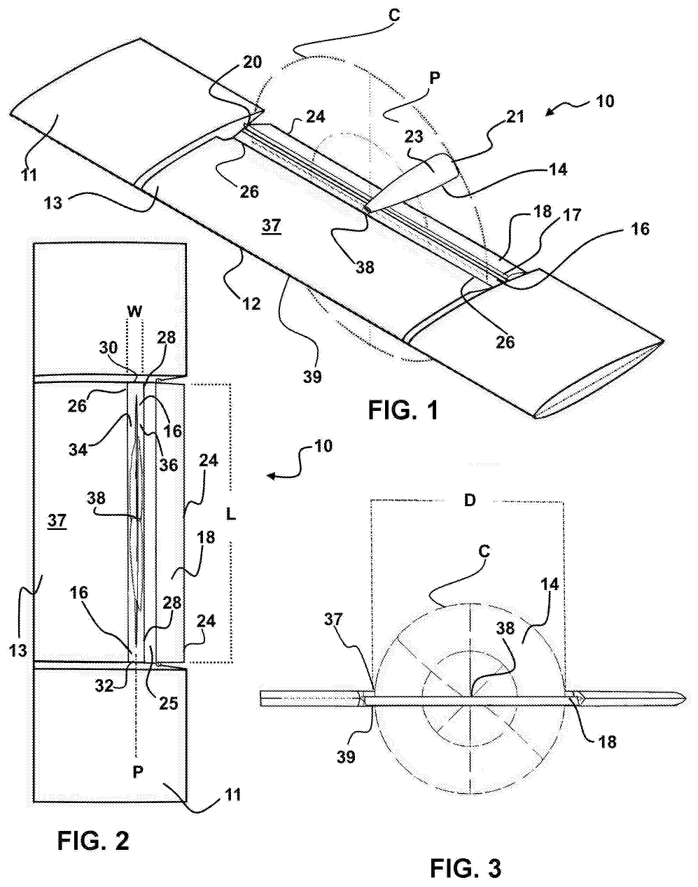

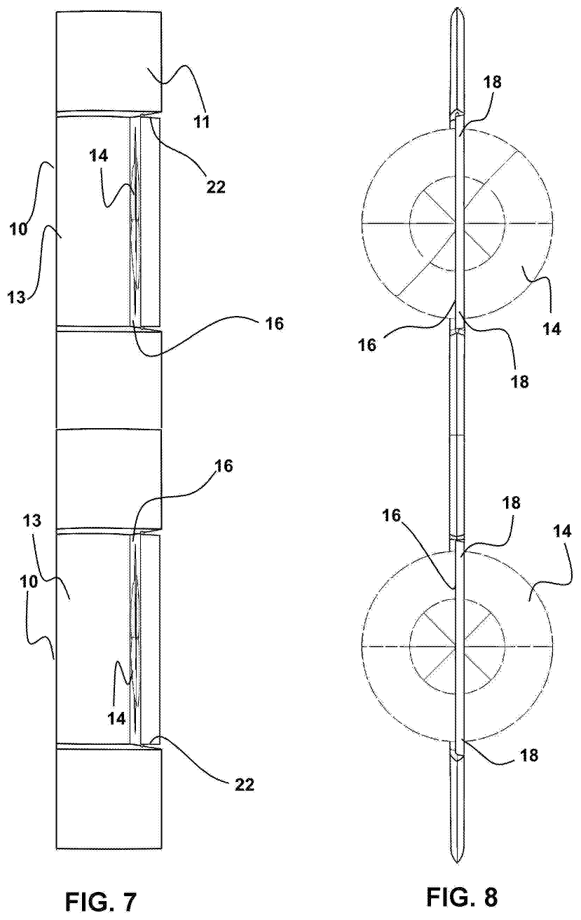

Now referring to drawings in FIGS. 1-12, wherein similar components are identified by like reference numerals, there is seen in FIG. 1, a front perspective view of a mode of the airfoil segment 10 herein. The airfoil segment 10 while adaptable for inclusion in other fluid flowing vehicles, is primarily intended in this application, to be included as a component of an aircraft wing 11, which itself is configured to be engaged at an attachment end of the wing 11 to an aircraft fuselage and to extend to a wing distal end or wing tip.

As depicted in FIGS. 1-3, and common to the different modes herein, there can be seen the airfoil segment 10 having an upper surface 37 and a lower surface 39 and a leading edge 12 of a forward or front portion 13 of the airfoil segment 10.

The airfoil includes this front portion 13 which extends between this leading edge 12 and a first side 26 of the slot 16 which runs across the front portion 13, opposite the leading edge 12. The slot 16 communicates between the upper surface 37 and the lower surface 39 of the airfoil segment 10.

The airfoil segment 10 also has an aft portion 22 which extends from a second side 28 of the slot 16, to a trailing edge 24 of the flap 18. The flap 18 is in a pivoting engagement to the segment 10 with a pivot 20. It should be noted that this aft portion 22 may be formed entirely by the flap 18 or, in a particularly preferred mode of the segment 10 herein, the aft portion 22 may include a fixed portion 25 located in between the second side 28 of the slot 16 and the moveable flap 18, and a second portion formed by the flap 18 itself. In any case, the aft portion 22 extends from the second side 28 of the slot 16 to the trailing edge 24 of the flap 16 or flaps if multiple are included.

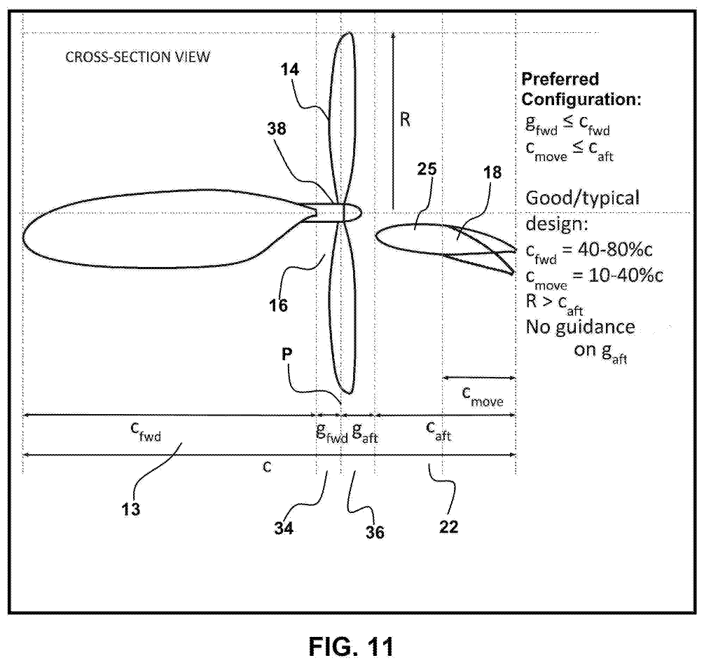

As shown in FIGS. 10 and 11, the design herein having the slot 16 with a propeller 14 operatively rotating therein, enables forming of a separate front portion 13 in front of the slot 16 and a rear or aft portion 22 behind the slot 16. This configuration provides for separate areas for lift through the provision of a forward propeller flow field 29, and downstream propeller flow field 31. In this configuration, the front portion 13 is formed with a width which is from 40-80 percent of the total width TW of the segment 10 between the leading edge 12 and the trailing edge 24 of the flap 18. The aft portion 22 running from the rear of the slot 16 to the trailing edge 24 on the flap 18 is formed with an aft width which 10-40% of the total width TW. This dual configuration ability is enabled in all modes herein having the propeller 14 rotating within a slot 16.

As shown, and common to all modes of the airfoil segment 10 herein, at least one propeller 14 is operatively positioned to rotate within the slot 16 formed in the airfoil segment 10. This slot 16 as shown, has a first side 26, which also defines a second end of the front portion 13 of the segment 10 which extends between the leading edge 12 and the first side 26 of the slot 16. The slot 16 has a second side 28 which is defined by either the first edge 17 of the flap 18, or a second side 28 of the slot 16 formed upon a fixed portion 25 of the airfoil segment 10 behind the propellor 14. The length of the first side 26 and the opposite second side 28 of the slot 16, define a length L, of the slot 16.

In all modes of the segment 10 herein, the slot 16, has a first end 30 opposite a second end 32. The width W of the slot 16 is defined by the distance between the first end 30 and second end 32 of the slot 16. As can be seen in FIG. 2 and FIG. 11, the slot is has a forward section 34 and has a rearward section 36.

The forward section 34 of the slot 16, is defined by the area of the slot 16 between the first side 26 of the slot 16 and the plane of rotation P of the propeller 16. As noted above, by plane of rotation is meant a planar area between the tips of the rotating blades of the propeller 16, when un-flexed, and the central hub 38 engaged to and spinning the blades. The rearward section 36 of the slot 16, is defined by the area of the slot 16 between the plane of rotation P of the propeller 16 and second side 28 of the slot 16. As noted above, and shown in FIG. 11 for example, the width W1 of the forward section 34 in a preferred mode of the segment 10 is preferably smaller than a width W2 of the rearward section 36. Further preferred, FIG. 11 shows width 34 less than width 36 but also that width 34 is less than the width 13 of the forward section

In all modes herein, the length L of the slot 16 must be larger than a diameter D of the plane of rotation P, running between the circumferential edge C thereof, which is determined by the rotating edge of the tips 21 of the blades 23. By larger is meant that L is at least substantially 1-20% larger than D. Because thermal or mechanical expansion and elongation of the blades 23 may occur during use and thereby enlarge the circumference C, this length L of the slot 16, must be sufficient between the two ends 30 and 32 of the slot 16, to accommodate such thermal and/or expansion of blades 23 while in motion, to prevent any contact of the blades 23 with portions of the segment 10. Such is easily calculable by those skilled in the art using conventional calculations and the thermal and other principals of materials employed to form the blades 23 and hub 38 and any conventional blade 23 connectors therebetween.

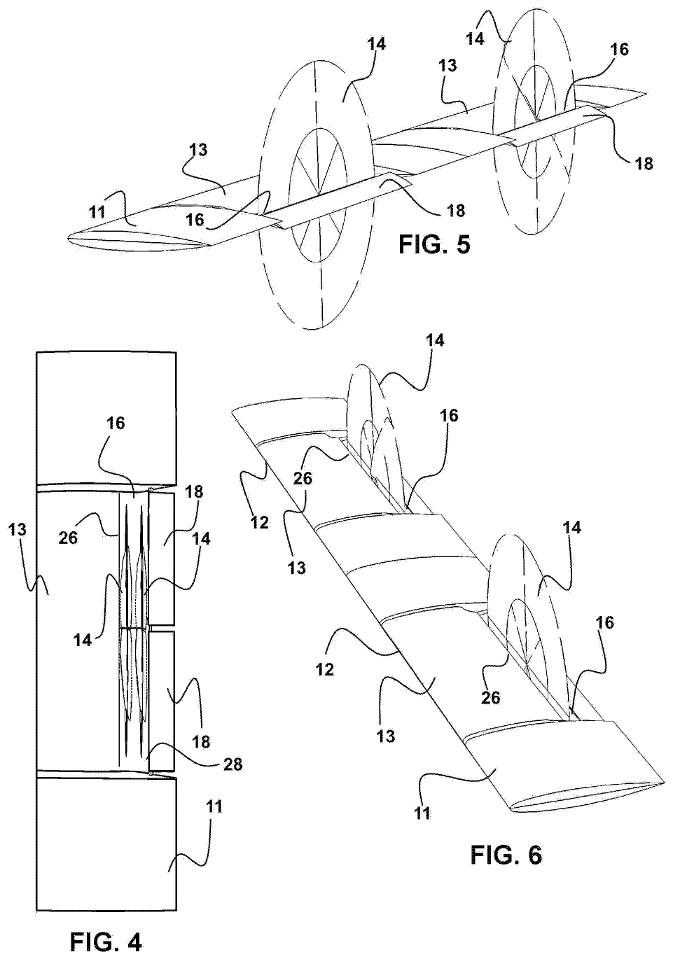

Shown in FIG. 4, is an overhead or top view of another preferred mode of the aircraft airfoil segment 10 herein, showing a particularly preferred mode having two counter rotating propellers 14 operatively positioned within a slot 16 positioned between the front portion 13 and the aft portion 22. While in FIG. 4, the aft portion is shown having two adjacent flaps 18 which may be individually pivoted, where two counter rotating propellers 14 are situated in the slot 16, a single flap 18 would be employed. The dual flaps 18 are primarily employed only when a single propeller 14 is operatively engaged in a slot 16. Additionally, while depicted in FIG. 4, as having the as having a first edge 17 of the flap 18 forming the rear of the slot 16, in many cases a fixed portion 25 as in FIG. 2, may also be positioned between the slot 16 and the flaps 18 to form a portion of the aft portion 22. The depicted dual flaps 18 may also be employed with any of the other modes herein.

FIGS. 5-8 depict views of another mode wherein the airfoil segment 10 herein, where a wing 11 has two slots 16 formed between the front portion 13 and the aft portion which would be formed as in the modes above, using only one or more flaps 18, or using a fixed portion 25 and a flap 18 to form the aft portion 22.

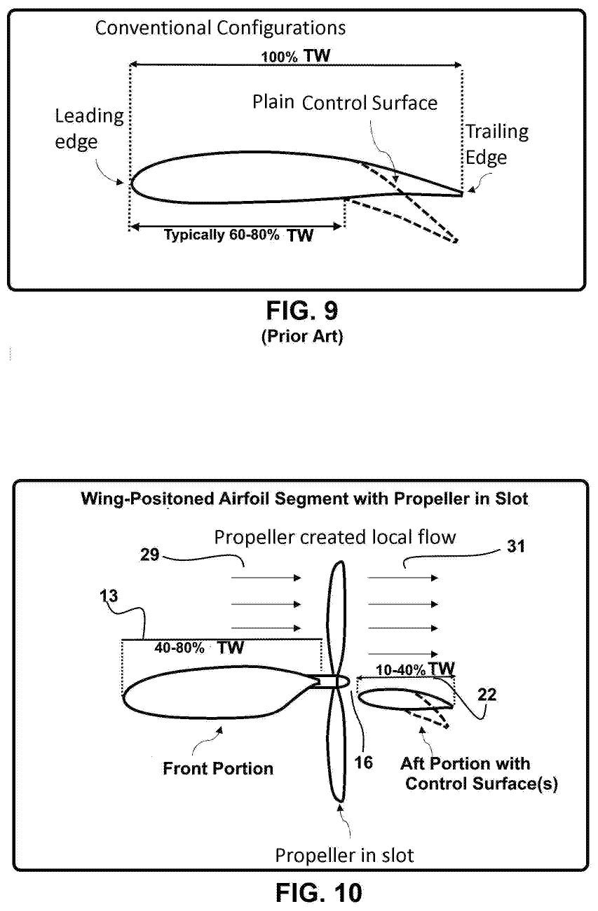

In FIG. 9 is shown an example of prior art conventional aircraft airfoil configurations for wings which do not position the propeller 14 operatively to rotate within a slot 16.

Shown in FIG. 10 is a graphic depiction of the configuration difference of the airfoil segment 10 as used in a wing 11 as opposed to that of FIG. 9. As shown, disclosed airfoil segment 10 herein positioned in a wing 11, generates a forward propeller flow field 29 with effects which allow the front portion 13 of the airfoil segment 10 to be formed in structurally more efficient thicker airfoils or higher lift-to-drag laminar airfoils or higher maximum lift coefficient designs. Further, as graphically depicted, it was found that the downstream propeller flow field 31 effects on the aft portion 22 of the airfoil segment 10 increases lift and allows flaps on the aft portion to provide enhanced control forces/moments at static or low flight speeds for short or vertical take-off.

In FIG. 11, is depicted preferred configurations that are available with the propeller 14 operatively rotating within a slot 16 formed into the segment 10 incorporated into an aircraft wing 11.

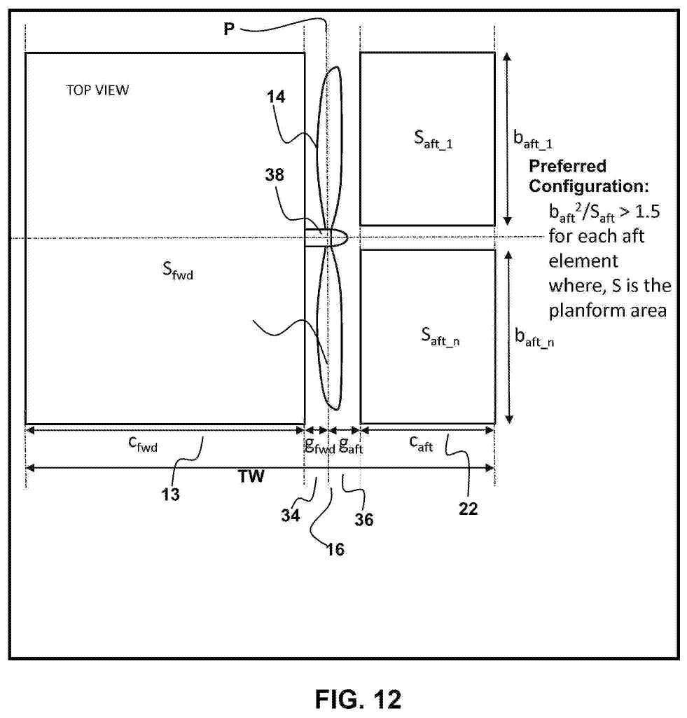

FIG. 12 is a view of variations of available preferred wing configurations enabled by the airfoil segment 10 which includes the propeller 14 operatively rotating within a slot 16 formed in the segment 10 of the wing 11.

The airfoil segment herein, while primarily disclosed for inclusion in a propeller driven aircraft wing, has other applications, potentially, and one skilled in the art could discern such. The explication of the features of this invention does not limit the claims of this application, and, other applications developed by those skilled in the art upon reviewing this application are considered to be included in this invention.

It is additionally noted and anticipated that although the device is shown in its most simple form and potential configurations, various components and aspects of the disclosed wing system may be differently shaped or slightly modified when forming the invention herein. As such those skilled in the art will appreciate the descriptions and depictions set forth in this disclosure are merely meant to portray examples of preferred modes of the slotted wing system herein within the overall scope and intent of the invention, and are not to be considered limiting in any manner.

Further, while all of the fundamental characteristics and features of the invention have been shown and described herein, with reference to particular embodiments thereof, a latitude of modification, various changes and substitutions are intended in the foregoing disclosure as well as the claims which follow, and it will be apparent that in some instances, some features of the invention may be employed without a corresponding use of other features without departing from the scope of the invention as set forth. It should also be understood that various substitutions, modifications, and variations may be made by those skilled in the art without departing from the spirit or scope of the invention. Consequently, all such modifications and variations and substitutions are included within the scope of the invention as defined by the following claims.

What is claimed is:

1. An airfoil for inclusion in an aircraft wing, comprising:
an airfoil segment, said airfoil segment having an upper surface opposite a lower surface thereof;
a slot communicating through said airfoil segment between said upper surface and said lower surface;
said airfoil segment having a front portion extending from a leading edge thereof to said slot;
said airfoil segment having aft portion extending from a first side thereof to a trailing edge;
said slot positioned in between said front portion and said aft portion of said airfoil segment; and
a propeller operatively positioned to rotate within said slot, said propeller projecting above said upper surface of said airfoil segment and projecting below said lower surface of said airfoil segment, whereby enhance aerodynamic forces and control of said wing at static or low flight speeds are provided by a forward propeller flow field which is generated between said leading edge of said front portion and said propeller, and a downstream propeller flow field is generated between said propeller and said trailing edge of said aft portion.

2. The airfoil component for inclusion in an aircraft wing of claim 1, additionally comprising:
said front portion of said airfoil segment extending from said leading edge to a first side of said slot; and
said aft portion extending from a second side of said slot to said trailing edge, said trailing edge positioned on a distal end of a pivoting flap engaged to said aft portion.

3. The airfoil component for inclusion in an aircraft wing of claim 1, wherein said propeller comprises:
two counter rotating propellers positioned within said slot.

4. The airfoil component for inclusion in an aircraft wing of claim 1, additionally comprising:
said slot having a forward section positioned between said first side of said slot and a plane of rotation of said propeller;
a first distance between said plane of rotation to said first side of said slot defining a width of said forward section;
said slot having a rearward section positioned between said second side of said slot and said plane of rotation of said propeller;
a second distance from said plane of rotation to said second side of said slot, defining a width of said rearward section; and
said first distance being smaller than said second distance.

5. The airfoil component for inclusion in an aircraft wing of claim 2, additionally comprising:
said slot having a forward section positioned between said first side of said slot and a plane of rotation of said propeller;
a first distance between said plane of rotation to said first side of said slot defining a width of said forward section;
said slot having a rearward section positioned between said second side of said slot and said plane of rotation of said propeller;
a second distance from said plane of rotation to said second side of said slot, defining a width of said rearward section; and
said first distance being smaller than said second distance.

6. The airfoil component for inclusion in an aircraft wing of claim 3, additionally comprising:
said slot having a forward section positioned between said first side of said slot and a plane of rotation of said propeller;
a first distance between said plane of rotation to said first side of said slot defining a width of said forward section;
said slot having a rearward section positioned between said second side of said slot and said plane of rotation of said propeller;
a second distance from said plane of rotation to said second side of said slot, defining a width of said rearward section; and
said first distance being smaller than said second distance.

7. The airfoil component for inclusion in an aircraft wing of claim 1, additionally comprising:
said airfoil segment having a total airfoil width extending across said airfoil segment between said leading edge and said trailing edge;
said front portion having a front portion width extending from said leading edge to said slot;
said aft portion having an aft portion width extending from said slot to said trailing edge;
said front portion width being between 40-80% of said total airfoil width; and
said aft portion width being between 10-40% of said total airfoil width.

8. The airfoil component for inclusion in an aircraft wing of claim 2, additionally comprising:
said airfoil segment having a total airfoil width extending across said airfoil segment between said leading edge and said trailing edge;
said front portion having a front portion width extending from said leading edge to said slot;
said aft portion having an aft portion width extending from said slot to said trailing edge;
said front portion width being between 40-80% of said total airfoil width; and
said aft portion width being between 10-40% of said total airfoil width.

9. The airfoil component for inclusion in an aircraft wing of claim 3, additionally comprising:
said airfoil segment having a total airfoil width extending across said airfoil segment between said leading edge and said trailing edge;
said front portion having a front portion width extending from said leading edge to said slot;
said aft portion having an aft portion width extending from said slot to said trailing edge;
said front portion width being between 40-80% of said total airfoil width; and
said aft portion width being between 10-40% of said total airfoil width.

10. The airfoil component for inclusion in an aircraft wing of claim 4, additionally comprising:
said airfoil segment having a total airfoil width extending across said airfoil segment between said leading edge and said trailing edge;
said front portion having a front portion width extending from said leading edge to said slot;
said aft portion having an aft portion width extending from said slot to said trailing edge;
said front portion width being between 40-80% of said total airfoil width; and
said aft portion width being between 10-40% of said total airfoil width.

11. The airfoil component for inclusion in an aircraft wing of claim 5, additionally comprising:
said airfoil segment having a total airfoil width extending across said airfoil segment between said leading edge and said trailing edge;
said front portion having a front portion width extending from said leading edge to said slot;
said aft portion having an aft portion with extending from said slot to said trailing edge;
said front portion width being between 40-80% of said total airfoil width; and
said aft portion width being between 10-40% of said total airfoil width.

12. The airfoil component for inclusion in an aircraft wing of claim 6, additionally comprising:
said airfoil segment having a total airfoil width extending across said airfoil segment between said leading edge and said trailing edge;
said front portion having a front portion width extending from said leading edge to said slot;
said aft portion having an aft portion width extending from said slot to said trailing edge;
said front portion width being between 40-80% of said total airfoil width; and
said aft portion width being between 10-40% of said total airfoil width.
